(19) United States
(12) Patent Application Publication
(10) Pub. No.: US 2024/0133593 A1
(43) Pub. Date: Apr. 25, 2024

(54) RANKINE CYCLE FOR RECOVERY OF THERMAL WASTE HEAT IN FUEL CELL

(71) Applicant: Advent Technologies, LLC., Livermore, CA (US)

(72) Inventors: Franklin Paul BARCINAS, Stockton, CA (US); Ian W. KAYE, Livermore, CA (US); Emory S. DE CASTRO, Nahant, MA (US)

(21) Appl. No.: 18/489,369

(22) Filed: Oct. 17, 2023

Related U.S. Application Data
(60) Provisional application No. 63/418,376, filed on Oct. 21, 2022.

(51) Int. Cl. F25B 11/04; F01K 27/02; H01M 8/04007; H01M 8/04029

(52) U.S. Cl. CPC F25B 11/04; F01K 27/02; H01M 8/04029; H01M 8/04059; H01M 8/04074; F25B 2400/141

(57) ABSTRACT

A cooling subsystem of a fuel cell assembly that employs the Rankine cycle to use the potential energy of a thermally pressurized fluid to generate electrical power. Waste heat from a fuel cell stack is transferred to working fluid in a heat exchanger. The working fluid in the condensed phase is pressurized, evaporated in a boiler or evaporator, and then fed to an expansion turbine which in turn provides rotary motion to an electric generator to generate useful electrical power. The fluid leaves the turbine as a lower pressured vapor, and is then condensed back to a fluid and pumped back to the evaporator to repeat the process.

### RELATED APPLICATION

This application claims the benefit of U.S. Provisional Application No. 63/418,376, filed on Oct. 21, 2022. The foregoing application is hereby incorporated by reference herein for all purposes.

### BACKGROUND OF THE INVENTION

The present disclosure generally relates to fuel cells. More specifically, the disclosure relates to thermal management of waste heat in fuel cells.

Fuel cells are electrochemical devices that can be used in a wide range of applications, including transportation, material handling, stationary, and portable power applications. Fuel cells use fuel and air to generate electricity by electrochemical reactions and release reaction products as exhaust. For example, the byproducts generated by methanol fuel cells are water vapor and carbon dioxide. In addition to electricity, some energy in the fuels is released as heat.

A cooling subsystem containing a heat exchanger attached to a fuel cell stack can help to dissipate some of the waste heat to prevent overheating of the fuel cell system. A large amount of waste heat that is generated during the operation of a typical high temperature polymer electrolyte membrane (HT-PEM) fuel cell is dissipated, requiring a significant amount of space and power to implement an air-cooled system. Recovering this waste heat can substantially improve the efficiency of a fuel cell and reduce the thermal load on existing cooling components.

### SUMMARY OF THE INVENTION

In accordance with an embodiment, a cooling subsystem for a fuel cell system having a fuel cell stack is provided. The cooling subsystem includes an evaporator, a turbo generator, a condenser, and a pump. The evaporator is configured to receive working fluid heated by waste heat generated by the fuel cell stack. The evaporator is also configured to further heat the working fluid using the waste heat. The turbo generator is downstream of and configured to receive heated working fluid from the evaporator. The turbo generator is configured to generate electrical power from the heated working fluid. The working fluid that leaves the turbo generator has a lower temperature and a lower pressure than that of the heated working fluid received from the evaporator. The condenser is downstream of and configured to receive working fluid from the turbo generator and condense the working fluid to a liquid. The pump is downstream of and configured to receive the liquid from the condenser and raise the pressure of the liquid before pumping the liquid into the evaporator.

In accordance with another embodiment, a method is provided for recycling waste heat generated by a fuel cell stack. A closed loop cooling system is provided. The cooling system includes an evaporator, a turbo generator, a condenser, and a pump. A fuel cell stack is operated. Waste heat from the fuel cell stack is captured in working fluid and the working fluid is evaporated. The evaporated working fluid is fed to a turbo generator to produce electric power.

In accordance with yet another embodiment, a method is provided for generating electrical power using a cooling subsystem of a fuel cell assembly. A fluid in a condensed phase is pressurized and the fluid is evaporated in an evaporator. The fluid is then fed from the evaporator into an expansion turbine configured to provide rotary motion to drive an electric generator to produce electric power.

### BRIEF DESCRIPTION OF THE DRAWINGS

The invention, together with further objects and advantages thereof, may best be understood by reference to the following description taken in conjunction with the accompanying drawings in which:

FIG. 1 shows the relationship between a fuel cell voltage and temperature vs. current.

FIG. 2 shows an example of a closed loop Rankine cycle cooling subsystem for a fuel cell system in accordance with an embodiment.

FIG. 3 is a perspective view of a fuel cell stack, with heat-exchangers attached, in accordance with an embodiment.

FIG. 4 is a flow chart of a method of recycling waste heat from a fuel cell in accordance with an embodiment.

### DETAILED DESCRIPTION OF EMBODIMENTS

The present invention relates generally to fuel cell systems. Embodiments of cooling subsystems of a fuel cell assembly are described herein. Like all powerplants, fuel cell systems must be cooled in order to operate. If fuel cell stacks are not cooled, then heat from inefficiencies in the fuel cell stack will cause temperatures to rise until damage occurs. As HT-PEM fuel cells generate substantial waste heat, recovering the waste heat can substantially improve the efficiency of a fuel cell and also reduce the thermal load on the cooling subsystem.

In embodiments described herein as examples, a HT-PEM fuel cell operates at a temperature in the range of about 160° C.-240° C. The fuel cell has a theoretical open circuit (Voc) of about 1.15V/cell and an operating voltage of roughly 0.6V/cell (Vcell). Those skilled in the art will understand that the power generation for the fuel cell stack is: Power(W)=0.6V×#cells×Current (I), while rejected heat Qstack(W)=(Voc−Vcell)×I. Therefore, the fuel cell power can be normalized to Vcell×I and stack heat can be normalized to (Voc−Vcell)×I.

For exemplary purposes, a fuel cell stack generating 1,000 W (or 1.0 kW) of heat is presented. The total electrical duty (W) of the fuel cell stack is heat plus power. Using the ratios above, the calculations below can be made:

Power=0.6×Duty

Heat=(1.15−0.6)/1.15×Duty=0.478×Duty

1,000 W=0.478×Duty

Duty=1,000/0.478=2091 W

FCPower=Duty−Heat=2091−1000=1091 W

Generator Power˜Q stack×20%

A simple electrical efficiency calculation shows that efficiency of the fuel cell is Power/Duty: 1091 W/2091 W=52.2%, which is exactly the same as Vcell/Voc.

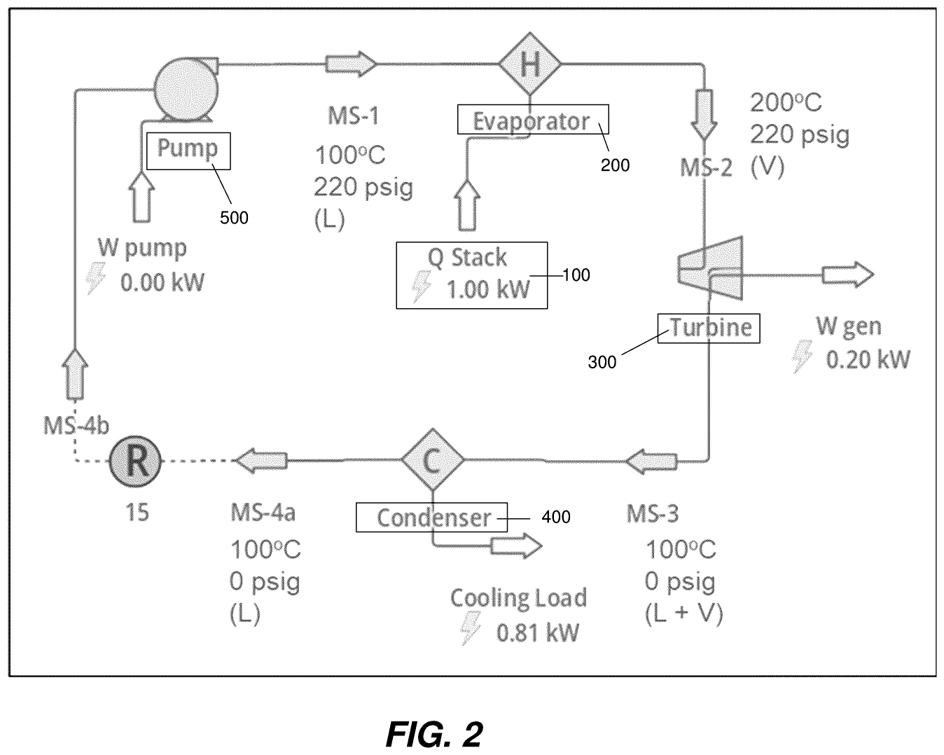

In embodiments described herein, by adding a turbo generator 300 (FIG. 2) on the fuel cell cooling subsystem loop, an additional 200 W of electrical power can be extracted. The electrical efficiency of the system would then increase to: FCPower+Turbo Generator Power/Duty or: 1091+200/2091=61.7%. Hence, the addition of a turbo generator 300 on the fuel cell cooling subsystem loop can increase the electrical efficiency from about 52% to about 62%. For applications that operate on expensive fuels, this efficiency boost would lead to a corresponding reduction in fuel consumption by 19% ([62%−52%]/52%). Those skilled in the art will understand that different operating factors such as cell voltage, fuel cell stack temperature, selection of working coolant, design pressure and so on can lead to further increases in the efficiency boost.

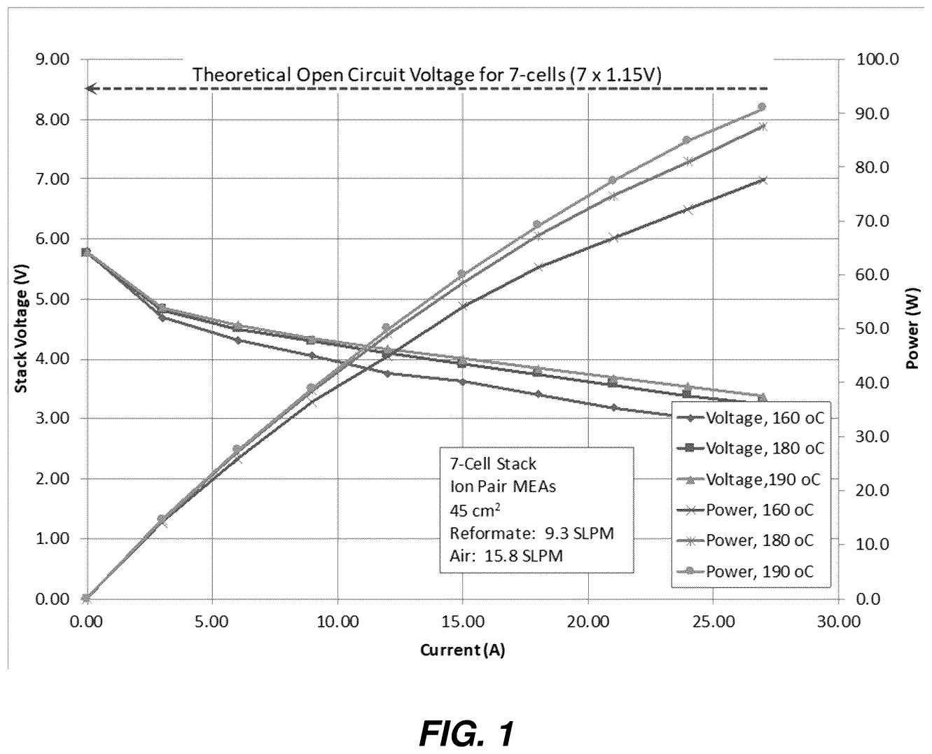

FIG. 1 shows the relationship between a fuel cell voltage and temperature vs. current. The relationship between duty, power and performance is shown in FIG. 1.

Embodiments described herein provide the ability for a fuel cell to run at very high power levels (i.e., to run the fuel cell at its peak power point of ˜0.45V/cell without a drop in overall net efficiency). When running the fuel cell at 0.45V/cell, it produces its peak power but at lower efficiency as discussed above. However, by adding a turbo generator 300, the waste heat generated by the fuel cell can be captured and used to generate additional power. The fuel cell system described above can be modified as follows:
Heat=1,000 W
Vcell=0.45V/cell
Efficiency=0.45/1.15=39.1%
   With these modifications, then:
Heat=(1.15−0.45)/1.15×Duty
1,000=0.6087×Duty
Duty=1643 W
FCpower=643 W
Turbo Generator Power=0.2×Heat=200 W
Total Power=200+643=843
Electrical efficiency=Total Power/Duty=843/1643=51.3%
Standard fuel cell nominal efficiency: 52.2%
Standard fuel cell peak power efficiency: 39.1%
Turbo generator fuel cell nominal efficiency: 61.7%
Turbo generator fuel cell peak power efficiency: 51.3%

The addition of the turbo generator 300 increases nominal efficiency from 52.2% to 61.7% (and reduced fuel consumption by 19%) and efficiency at peak power from 39.1% to 51.3% (and reduced fuel consumption by 31%.

Because the turbo generator fuel cell system retains good efficiency at lower cell voltages, there is additional design flexibility. For example, those skilled in the art will understand that running a fuel cell at lower voltages yields a smaller fuel cell. However, this smaller and cheaper fuel cell has lower efficiency and hence leads to higher fuel consumption rates. The total cost of ownership is a combination of the fuel cell capital cost and the fuel usage. Therefore, fuel cell manufacturers tend to specify that peak power is only available for short bursts of time (such as accelerating a vehicle.) With the turbo generator fuel cell described herein, the fuel cell retains good efficiency even under lower cell voltages, and the cost and size of this fuel cell will be lower than existing systems, and will have higher efficiency.

Fuel cells are most often paired with a hybrid battery. The hybrid battery is sized to start up the fuel cell and provide power that is greater than what the fuel cell can deliver at any given time in the product duty cycle. If the fuel cell can deliver more power efficiently, then the battery can be made correspondingly smaller and cheaper.

Applications such as vehicle propulsion, stationary power, shipboard and aviation propulsion, and auxiliary power modules can benefit from the embodiments described herein. Described embodiments are suitable for fuel cell systems above 1 kW net power level due to the difficulty in manufacturing turbo generators below that power level. However, small turbines can be used to allow for lower power level usage.

In embodiments described herein, the Rankine Cycle, which is a thermodynamic cycle that converts heat into work, is integrated with a HT-PEMFC to recover waste heat in a fuel cell. The addition of a turbogenerator 300 to the closed fuel cell cooling subsystem loop allows for waste heat recovery.

The Rankine cycle utilizes the potential energy of a thermally pressurized fluid to generate electrical power. The fundamentals of the cycle are relatively straightforward. A fluid in the condensed phase is pressurized to a specific value, evaporated in a boiler or evaporator, and then is fed to an expansion turbine which in turn provides rotary motion to an electric generator from which useful electrical power is obtained. The fluid leaves the turbine as a lower pressured vapor, and is then condensed back to a fluid and pumped back to the evaporator to repeat the process. The theoretical maximum efficiency that can be obtained from this process is given by the Carnot efficiency, expressed by Equation (1) below:

$${η}_{Carnot} = 1 - \frac{{T}_{C}}{{T}_{H}} \qquad ( 1 )$$

where T_{H} and T_{C} respectively are the operating temperatures of the evaporator and condenser in units of Kelvin. From Equation (1), the dependence of the amount of energy that can be recovered on these temperatures is made clear, as is why the lower operating temperature of a PBI fuel cell is a limiting factor that is overcome substantially by the ion-pair membrane electrode assembly (MEA). As an illustrative example, substituting the typical operating range of a PBI fuel cell (165° C., 438.15K) and an ion-pair MEA (200° C., 473.15K) as T_{H}, and the typical room temperature boiling point of water (100° C., 373K) as T_{C}, η_{Carnot} comes out to be about 14.8% for PBI and 21.2% for the ion-pair MEA at these conditions, an increase in potential recovery of 6.4%. The Carnot efficiency assumes adiabatic operation, which provides a theoretical upper bound on the performance of any real system. Thermal energy recovery of 12-15% is a more realistic figure, which can possibly be further improved with the addition of regeneration cycles, or reducing the operating pressure of the condenser to slightly below ambient conditions. A preliminary simulation has been conducted utilizing DWSIM, an open-source chemical process simulation software, to provide further illustration and insight.

The simulation below assumes 1 kW of heat is generated from the fuel cell stack. Given a theoretical OCV of 1.15V (computed by Gibbs free energy calculations), an operating voltage of 0.6V and a target current density of 0.8 A/cm2 with the ion-pair MEA, 1 kW of heat rejection equates to about 1080 W of electricity generated for a 45 cm2 MEA, shown from a simple energy balance (Equation 2):

Q_{rejected}=(V_{OCV}−V_{Op})i (2)

where V_{OCV}, Vₒₚ, and i are the theoretical open circuit voltage, the operating voltage, and the load current, respectively.

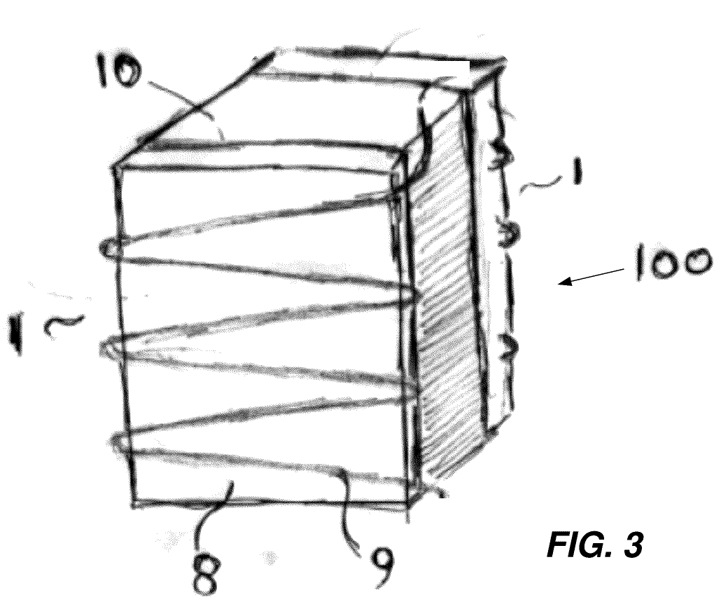

FIG. 2 shows an example of a closed loop Rankine cycle cooling subsystem for a fuel cell system. In the example shown in FIG. 2, the fuel cell assembly 100 generates 1.0 kW (or 1000 W) of waste heat. FIG. 3 is a perspective view of a fuel cell assembly 100 in accordance with an embodiment. The fuel cell assembly 100 has a fuel cell stack 10 with heat-exchangers 1 attached to side faces of the fuel cell stack 10. The fuel cell stack 10 is constructed from alternating layers of bipolar plates and MEAs, where the edges of the bipolar plates comprise at least one surface for heat exchange to an external heat exchanger 1. Waste heat generated by fuel cell stack 10 is dissipated by the heat exchanger 1 and the waste heat is transferred from the fuel cell stack 10 to the working fluid in the heat exchanger 1. The working fluid flowing through the heat exchanger 1 is heated by the waste heat. In the embodiment of the fuel cell assembly 100 shown in FIG. 1, two heat exchangers 1 are mated to two exterior side faces of the fuel cell stack 10. In the illustrated embodiment, each heat exchanger 1 is a plate-and-tube type heat exchanger formed of a plate 8 and tube 9 through which working fluid can flow. It will be understood that other types of heat exchangers may be used in other embodiments.

As shown in FIG. 2, the heated working fluid from the heat exchanger 1 of the fuel cell assembly 100 flows into the evaporator 200, which further heats the working fluid using the waste heat. The evaporator 200 further heats the working fluid until it reaches a vapor state. For example, if the working fluid is water, the evaporator 200 further heats the water and turns it into steam.

The working fluid then flows from the evaporator 200 into the turbogenerator or turbine 300. The turbo generator 300 generates electrical power from the heated working fluid, which is heated into a vapor (or steam in the case of water as the working fluid). As the vapor expands through turbine blades, it does mechanical work. In an embodiment, the turbo generator 300 is an expansion turbine, which provides rotary motion to drive an electric generator from which useful electrical power is obtained. The expansion of the vapor causes the vapor to lose pressure. Thus, when the working fluid leaves the turbo generator 300, it has a lower temperature and a lower pressure compared to when it entered the turbo generator 300.

The working fluid then flows into a condenser 400 downstream of the turbo generator 300 where it condenses the working fluid to a liquid. A pump 500 receives the condensed liquid from the condenser 400 and raises the pressure of the liquid before pumping the liquid back into heat exchanger 1 to capture more waste heat from the fuel cell stack 10 before it enters the evaporator 200.

It will be noted that in FIG. 2, L and V denote phases that are present in the material stream, where L is liquid and V is vapor. The values shown above are with an operating temperature for the ion-pair MEA of 200° C., 220 psig of pressure, and with 260 g/min of water, and ideal component efficiencies in the Rankine cycle. With these conditions, 20% of heat lost heat is recovered. Incorporating losses in the turbine will likely reduce this number to 14% for a 70% efficient turbine, which still yields substantial improvement.

| | (Pₜₒₜₐₗ)/ |
|---|---|
| Configuration | (P_{electrical}) |
| FC | 48.1% |
| FC + RC | 61.5% |
| FC + RC | 58.7% |
| (70% eff. Turbine) | |

Note:
FC = Fuel Cell,
RC = Rankine Cycle

A table providing the thermodynamic parameters of each stream in greater detail is provided below.

| Parameter | MS-1 | MS-2 | MS-3 | MS-4a | MS-4b |
|---|---|---|---|---|---|
| Temperature (K) | 373.355 | 475.073 | 373.124 | 373.124 | 373.124 |
| Pressure (Pa) | 1.62E+06 | 1.62E+06 | 101325 | 101325 | 101325 |
| Mass Flow (kg/s) | 0.000423 | 0.000423 | 0.000423 | 0.000423 | 0.000423 |
| Molar Flow (mol/s) | 0.023469 | 0.023469 | 0.023469 | 0.023469 | 0.023469 |
| Volumetric Flow (m3/s) | 4.41E−07 | 5.17E−05 | 0.000598 | 4.41E−07 | 4.41E−07 |
| Density (Mixture) (kg/m3) | 958.917 | 8.17092 | 0.707307 | 958.373 | 958.373 |
| Molecular Weight (Mixture) (kg/kmol) | 18.0153 | 18.0153 | 18.0153 | 18.0153 | 18.0153 |
| Specific Enthalpy (Mixture) (kJ/kg) | 421.101 | 2793.2 | 2325.39 | 418.991 | 418.991 |
| Specific Entropy (Mixture) (kJ/[kg · K]) | 1.30814 | 6.41598 | 6.41598 | 1.30672 | 1.30672 |
| Molar Enthalpy (Mixture) (kJ/kmol) | 7586.25 | 50320.2 | 41892.5 | 7548.24 | 7548.24 |
| Molar Entropy (Mixture) (kJ/[kmol · K]) | 23.5665 | 115.586 | 115.586 | 23.541 | 23.541 |
| Thermal Conductivity (Mixture) (W/[m · K]) | 0.679992 | 0.040484 | 0.126573 | 0.67909 | 0.67909 |
| Density (Vapor) (kg/m3) | 0 | 8.17092 | 0.597623 | 0 | 0 |
| Molecular Weight (Vapor) (kg/kmol) | 0 | 18.0153 | 18.0153 | 0 | 0 |
| Specific Enthalpy (Vapor) (kJ/kg) | 0 | 2793.2 | 2675.53 | 0 | 0 |
| Specific Entropy (Vapor) (kJ/[kg · K]) | 0 | 6.41598 | 7.35439 | 0 | 0 |
| Molar Enthalpy (Vapor) (kJ/kmol) | 0 | 50320.2 | 48200.4 | 0 | 0 |
| Molar Entropy (Vapor) (kJ/[kmol · K]) | 0 | 115.586 | 132.491 | 0 | 0 |
| Thermal Conductivity (Vapor) (W/[m · K]) | 0 | 0.040484 | 0.025093 | 0 | 0 |
| Kinematic Viscosity (Vapor) (m2/s) | 0 | 1.93E−06 | 2.05E−05 | 0 | 0 |
| Dynamic Viscosity (Vapor) (Pa · s) | 0 | 1.58E−05 | 1.23E−05 | 0 | 0 |
| Heat Capacity (Vapor) (kJ/[kg · K]) | 0 | 3.01939 | 2.07739 | 0 | 0 |
| Heat Capacity Ratio (Vapor) | NaN | 1.4506 | 1.33712 | NaN | NaN |
| Mass Flow (Vapor) (kg/s) | 0 | 0.000423 | 0.000357 | 0 | 0 |
| Molar Flow (Vapor) (mol/s) | 0 | 0.023469 | 0.019827 | 0 | 0 |
| Volumetric Flow (Vapor) (m3/s) | 0 | 5.17E−05 | 0.000598 | 0 | 0 |
| Compressibility Factor (Vapor) | 0 | 0.903289 | 0.984616 | 0 | 0 |
| Molar Fraction (Vapor) | 0 | 1 | 0.844831 | 0 | 0 |
| Mass Fraction (Vapor) | 0 | 1 | 0.844831 | 0 | 0 |
| Volumetric Fraction (Vapor) | 0 | 1 | 0.999885 | 0 | 0 |
| Density (Overall Liquid) (kg/m3) | 958.917 | NaN | 958.373 | 958.373 | 958.373 |
| Molecular Weight (Overall Liquid) (kg/kmol) | 18.0153 | NaN | 18.0153 | 18.0153 | 18.0153 |
| Specific Enthalpy (Overall Liquid) (kJ/kg) | 421.101 | 0 | 418.991 | 418.991 | 418.991 |
| Specific Entropy (Overall Liquid) (kJ/[kg · K]) | 1.30814 | 0 | 1.30672 | 1.30672 | 1.30672 |
| Molar Enthalpy (Overall Liquid) (kJ/kmol) | 7586.25 | NaN | 7548.24 | 7548.24 | 7548.24 |
| Molar Entropy (Overall Liquid) (kJ/[kmol · K]) | 23.5665 | NaN | 23.541 | 23.541 | 23.541 |
| Thermal Conductivity (Overall Liquid) | 0.679992 | 0 | 0.67909 | 0.67909 | 0.67909 |
| (W/[m · K]) | | | | | |
| Kinematic Viscosity (Overall Liquid) (m2/s) | 2.94E−07 | NaN | 2.94E−07 | 2.94E−07 | 2.94E−07 |
| Dynamic Viscosity (Overall Liquid) (Pa · s) | 0.000282 | 0 | 0.000282 | 0.000282 | 0.000282 |
| Heat Capacity (Overall Liquid) (kJ/[kg · K]) | 4.21342 | 0 | 4.21661 | 4.21661 | 4.21661 |
| Heat Capacity Ratio (Overall Liquid) | 1.11927 | NaN | 1.11911 | 1.11911 | 1.11911 |
| Mass Flow (Overall Liquid) (kg/s) | 0.000423 | 0 | 6.56E−05 | 0.000423 | 0.000423 |
| Molar Flow (Overall Liquid) (mol/s) | 0.023469 | 0 | 0.003642 | 0.023469 | 0.023469 |
| Volumetric Flow (Overall Liquid) (m3/s) | 4.41E−07 | 0 | 6.85E−08 | 4.41E−07 | 4.41E−07 |
| Compressibility Factor (Overall Liquid) | 0.009794 | 0 | 0.000614 | 0.000614 | 0.000614 |
| Molar Fraction (Overall Liquid) | 1 | 0 | 0.155169 | 1 | 1 |
| Mass Fraction (Overall Liquid) | 1 | 0 | 0.155169 | 1 | 1 |
| Volumetric Fraction (Overall Liquid) | 1 | 0 | 0.000115 | 1 | 1 |
| Density (Liquid 1) (kg/m3) | 958.917 | 0 | 958.373 | 958.373 | 958.373 |
| Molar Weight (Liquid 1) (kg/kmol) | 18.0153 | 0 | 18.0153 | 18.0153 | 18.0153 |
| Specific Enthalpy (Liquid 1) (kJ/kg) | 421.101 | 0 | 418.991 | 418.991 | 418.991 |
| Specific Entropy (Liquid 1) (kJ/[kg · K]) | 1.30814 | 0 | 1.30672 | 1.30672 | 1.30672 |
| Molar Enthalpy (Liquid 1) (kJ/kmol) | 7586.25 | 0 | 7548.24 | 7548.24 | 7548.24 |
| Molar Entropy (Liquid 1) (kJ/[kmol · K]) | 23.5665 | 0 | 23.541 | 23.541 | 23.541 |
| Thermal Conductivity (Liquid 1) (W/[m · K]) | 0.679992 | 0 | 0.67909 | 0.67909 | 0.67909 |
| Kinematic Viscosity (Liquid 1) (m2/s) | 2.94E−07 | 0 | 2.94E−07 | 2.94E−07 | 2.94E−07 |
| Dynamic Viscosity (Liquid 1) (Pa · s) | 0.000282 | 0 | 0.000282 | 0.000282 | 0.000282 |
| Heat Capacity (Liquid 1) (kJ/[kg · K]) | 4.21342 | 0 | 4.21661 | 4.21661 | 4.21661 |
| Heat Capacity Ratio (Liquid 1) | 1.11927 | NaN | 1.11911 | 1.11911 | 1.11911 |
| Mass Flow (Liquid 1) (kg/s) | 0.000423 | 0 | 6.56E−05 | 0.000423 | 0.000423 |
| Molar Flow (Liquid 1) (mol/s) | 0.023469 | 0 | 0.003642 | 0.023469 | 0.023469 |
| Volumetric Flow (Liquid 1) (m3/s) | 4.41E−07 | 0 | 6.85E−08 | 4.41E−07 | 4.41E−07 |
| Compressibility Factor (Liquid 1) | 0.009794 | 0 | 0.000614 | 0.000614 | 0.000614 |
| Molar Fraction (Liquid 1) | 1 | 0 | 0.155169 | 1 | 1 |
| Mass Fraction (Liquid 1) | 1 | 0 | 0.155169 | 1 | 1 |
| Volumetric Fraction (Liquid 1) | 1 | 0 | 0.000115 | 1 | 1 |
| Molar Fraction (Mixture)/Water | 1 | 1 | 1 | 1 | 1 |
| Mass Fraction (Mixture)/Water | 1 | 1 | 1 | 1 | 1 |
| Molar Flow (Mixture)/Water (mol/s) | 0.023469 | 0.023469 | 0.023469 | 0.023469 | 0.023469 |
| Mass Flow (Mixture)/Water (kg/s) | 0.000423 | 0.000423 | 0.000423 | 0.000423 | 0.000423 |
| Molar Fraction (Vapor)/Water | 0 | 1 | 1 | 0 | 0 |
| Molar Fraction (Overall Liquid)/Water | 1 | NaN | 1 | 1 | 1 |
| Molar Fraction (Liquid 1)/Water | 1 | 0 | 1 | 1 | 1 |
| Mass Fraction (Vapor)/Water | 0 | 1 | 1 | 0 | 0 |
| Mass Fraction (Overall Liquid)/Water | 1 | NaN | 1 | 1 | 1 |
| Mass Fraction (Liquid 1)/Water | 1 | 0 | 1 | 1 | 1 |
| Molar Flow (Vapor)/Water (mol/s) | 0 | 0.023469 | 0.019827 | 0 | 0 |
| Molar Flow (Overall Liquid)/Water (mol/s) | 0.023469 | NaN | 0.003642 | 0.023469 | 0.023469 |
| Molar Flow (Liquid 1)/Water (mol/s) | 0.023469 | 0 | 0.003642 | 0.023469 | 0.023469 |
| Molar Flow (Liquid 2)/Water (mol/s) | 0 | 0 | 0 | 0 | 0 |
| Molar Flow (Aqueous)/Water (mol/s) | | | | | |
| Mass Flow (Vapor)/Water (kg/s) | 0 | 0.000423 | 0.000357 | 0 | 0 |
| Mass Flow (Overall Liquid)/Water (kg/s) | 0.000423 | NaN | 6.56E−05 | 0.000423 | 0.000423 |
| Mass Flow (Liquid 1)/Water (kg/s) | 0.000423 | 0 | 6.56E−05 | 0.000423 | 0.000423 |
| Bubble Pressure at Stream Temperature (Pa) | 102161 | 1.62E+06 | 101325 | 101325 | 101325 |
| Dew Pressure at Stream Temperature (Pa) | 102161 | 1.62E+06 | 101325 | 101325 | 101325 |
| Bubble Temperature at Stream Pressure (K) | 475.073 | 475.073 | 373.124 | 373.124 | 373.124 |
| Dew Temperature at Stream Pressure (K) | 475.073 | 475.073 | 373.124 | 373.124 | 373.124 |
| Phases | L | V | V + L | L | L |
| Isothermal Compressibility (Vapor) (1/Pa) | 0 | 0.009906 | 0.010004 | 0 | 0 |
| Bulk Modulus (Vapor) (Pa) | 0 | 100.95 | 99.9637 | 0 | 0 |
| Speed of Sound (Vapor) (m/s) | 0 | 4.23343 | 14.9552 | 0 | 0 |
| Joule-Thomson Coefficient (Vapor) (K/Pa) | 0 | 1.51E−08 | 7.76E−08 | 0 | 0 |
| Internal Energy (Vapor) (kJ/kg) | 0 | 2595.15 | 2505.98 | 0 | 0 |
| Gibbs Free Energy (Vapor) (kJ/kg) | 0 | −254.858 | −68.5683 | 0 | 0 |
| Helmholtz Free Energy (Vapor) (kJ/kg) | 0 | −452.9 | −238.115 | 0 | 0 |
| Internal Energy (Overall Liquid) (kJ/kg) | 419.413 | 0 | 418.885 | 418.885 | 418.885 |
| Gibbs Free Energy (Overall Liquid) (kJ/kg) | −67.2987 | 0 | −68.5798 | −68.5798 | −68.5798 |
| Helmholtz Free Energy (Overall Liquid) | −68.9862 | 0 | −68.6855 | −68.6855 | −68.6855 |
| (kJ/kg) | | | | | |
| Bulk Modulus (Liquid 1) (Pa) | 2.05E+09 | 0 | 2.04E+09 | 2.04E+09 | 2.04E+09 |
| Speed of Sound (Liquid 1) (m/s) | 1547.96 | 0 | 1544.35 | 1544.35 | 1544.35 |
| Joule−Thomson Coefficient (Liquid 1) (K/Pa) | −1.16E−10 | 0 | −1.16E−10 | −1.16E−10 | −1.16E−10 |
| Internal Energy (Liquid 1) (kJ/kg) | 419.413 | 0 | 418.885 | 418.885 | 418.885 |
| Gibbs Free Energy (Liquid 1) (kJ/kg) | −67.2987 | 0 | −68.5798 | −68.5798 | −68.5798 |
| Helmholtz Free Energy (Liquid 1) (kJ/kg) | −68.9862 | 0 | −68.6855 | −68.6855 | −68.6855 |
| Isothermal Compressibility (Liquid 1) (1/Pa) | 4.87E−10 | 0 | 4.90E−10 | 4.90E−10 | 4.90E−10 |
| Internal Energy (Mixture) (kJ/kg) | 419.413 | 2595.15 | 2182.13 | 418.885 | 418.885 |
| Gibbs Free Energy (Mixture) (kJ/kg) | −67.2987 | −254.858 | −68.5701 | −68.5798 | −68.5798 |
| Helmholtz Free Energy (Mixture) (kJ/kg) | −68.9862 | −452.9 | −211.825 | −68.6855 | −68.6855 |
| Molar Internal Energy (Mixture) (kJ/kmol) | 7555.85 | 46752.4 | 39311.7 | 7546.33 | 7546.33 |
| Molar Gibbs Free Energy (Mixture) (kJ/kmol) | −1212.4 | −4591.34 | −1235.31 | −1235.48 | −1235.48 |
| Molar Helmholtz Free Energy (Mixture) | −1242.81 | −8159.11 | −3816.08 | −1237.39 | −1237.39 |
| (kJ/kmol) | | | | | |
| Molar Internal Energy (Vapor) (kJ/kmol) | 0 | 46752.4 | 45146 | 0 | 0 |
| Molar Gibbs Free Energy (Vapor) (kJ/kmol) | 0 | −4591.34 | −1235.28 | 0 | 0 |
| Molar Helmholtz Free Energy (Vapor) | 0 | −8159.11 | −4289.71 | 0 | 0 |
| (kJ/kmol) | | | | | |
| Molar Internal Energy (Overall Liquid) | 7555.85 | NaN | 7546.33 | 7546.33 | 7546.33 |
| (kJ/kmol) | | | | | |
| Molar Gibbs Free Energy (Overall Liquid) | −1212.4 | NaN | −1235.48 | −1235.48 | −1235.48 |
| (kJ/kmol) | | | | | |
| Molar Helmholtz Free Energy (Overall Liquid) | −1242.81 | NaN | −1237.39 | −1237.39 | −1237.39 |
| (kJ/kmol) | | | | | |
| Molar Internal Energy (Liquid 1) (kJ/kmol) | 7555.85 | 0 | 7546.33 | 7546.33 | 7546.33 |
| Molar Gibbs Free Energy (Liquid 1) (kJ/kmol) | −1212.4 | 0 | −1235.48 | −1235.48 | −1235.48 |
| Molar Helmholtz Free Energy (Liquid 1) | −1242.81 | 0 | −1237.39 | −1237.39 | −1237.39 |
| (kJ/kmol) | | | | | |
| Molarity (Mixture)/Water (mol/m3) | 53228 | 453.555 | 39.2615 | 53197.8 | 53197.8 |
| Molarity (Vapor Phase)/Water (mol/m3) | 0 | 453.555 | 33.1731 | 0 | 0 |
| Molarity (Overall Liquid)/Water (mol/m3) | 53228 | 0 | 53197.8 | 53197.8 | 53197.8 |
| Molarity (Liquid Phase 1)/Water (mol/m3) | 53228 | 0 | 53197.8 | 53197.8 | 53197.8 |
| Molarity (Liquid Phase 2)/Water (mol/m3) | 0 | 0 | 0 | 0 | 0 |
| Molarity (Aqueous Phase)/Water (mol/m3) | 0 | 0 | 0 | 0 | 0 |
| Molarity (Solid Phase)/Water (mol/m3) | 0 | 0 | 0 | 0 | 0 |
| Energy Flow (KW) | −5.49708 | −4.49416 | −4.69195 | −5.49798 | −5.49798 |
| Fugacity Coefficient, Vapor Phase/Water (Pa) | 1 | 1 | 1 | 0 | 0 |
| Fugacity Coefficient, Liquid Phase 1/Water | 1 | 1 | 1 | 1 | 1 |
| (Pa) | | | | | |
| Diffusion Coefficient, Vapor Phase/Water | −∞ | −∞ | −∞ | −∞ | −∞ |
| (m2/s) | | | | | |
| Diffusion Coefficient, Liquid Phase 1/Water | NaN | NaN | NaN | NaN | NaN |
| (m2/s) | | | | | |
| Diffusion Coefficient, Liquid Phase 2/Water | NaN | NaN | NaN | NaN | NaN |
| (m2/s) | | | | | |
| Ideal Gas Heat Capacity Cp (Vapor) (kJ/kg) | 2.34064 | 1.93621 | 1.89106 | 0 | 0 |
| Ideal Gas Heat Capacity Cp (Liquid 1) (kJ/kg) | 1.89115 | 1.93621 | 1.89106 | 1.89106 | 1.89106 |
| Ideal Gas Heat Capacity Ratio (Vapor) | 1.24559 | 1.31294 | 1.32282 | 0 | 0 |
| Ideal Gas Heat Capacity Ratio (Liquid 1) | 1.3228 | 1.31294 | 1.32282 | 1.32282 | 1.32282 |

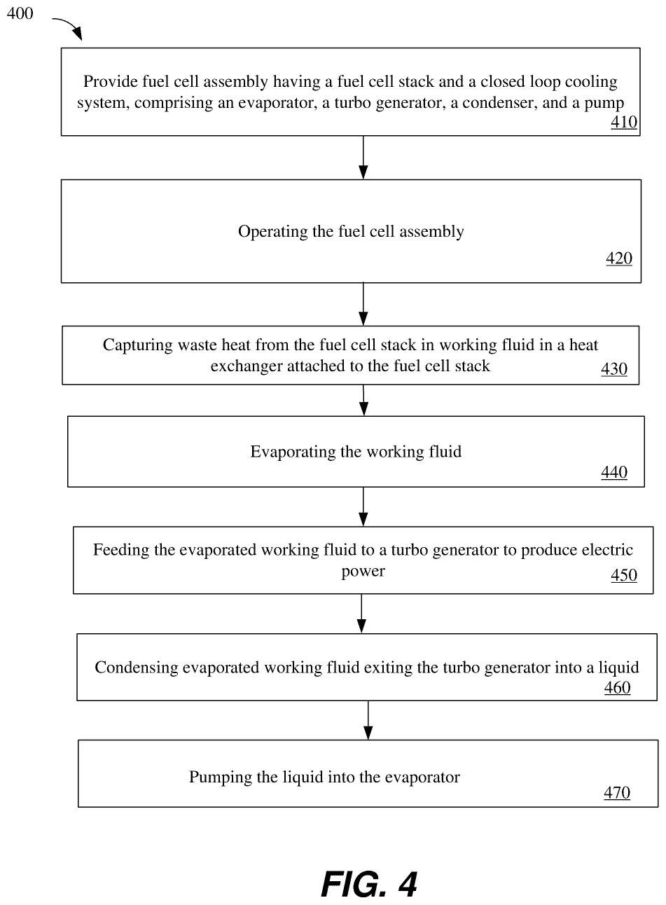

FIG. 4 is a flow chart of a method 400 of recycling waste heat from a fuel cell in accordance with an embodiment. In Step 410, a fuel cell assembly having a fuel cell stack and a closed loop cooling system is provided. The cooling system includes an evaporator, a turbo generator, a condenser, and a pump. In step 420, the fuel cell assembly is operated and waste heat is generated by the fuel cell stack during operation. Waste heat from the fuel cell stack is captured in working fluid in a heat exchanger attached to the fuel cell stack in Step 430.

In step 440, the working fluid from the heat exchanger is evaporated into a vapor, which is then fed into to a turbo generator to produce electric power in Step 450. evaporated working fluid exiting the turbo generator is condensed into a liquid in Step 460. The liquid is then pressurized and then pumped back into the evaporator in Step 470.

In view of the foregoing, it should be apparent that the present embodiments are illustrative and not restrictive and the invention is not limited to the details given herein but may be modified within the scope and equivalents of the appended claims.

What is claimed is:

1. A cooling subsystem for a fuel cell system having a fuel cell stack, the cooling subsystem comprising:
an evaporator configured to receive working fluid heated by waste heat generated by the fuel cell stack, wherein the evaporator is configured to further heat the working fluid using the waste heat; and
a turbo generator downstream of and configured to receive heated working fluid from the evaporator, wherein the turbo generator is configured to generate electrical power from the heated working fluid, wherein the working fluid that leaves the turbo generator has a lower temperature and a lower pressure than that of the heated working fluid received from the evaporator;
a condenser downstream of and configured to receive working fluid from the turbo generator and condense the working fluid to a liquid;
a pump downstream of and configured to receive the liquid from the condenser and raise a pressure of the liquid before pumping the liquid into the evaporator.

2. The cooling subsystem as recited in claim 1, further comprising at least one heat exchanger attached to a face of the fuel cell stack and configured to dissipate waste heat from the fuel cell stack and wherein working fluid from the at least one heat exchanger flows from the at least one heat exchanger to the evaporator.

3. The cooling subsystem as recited in claim 2, wherein the pump is configured to pump the liquid into the at least one heat exchanger before the liquid enters the evaporator.

4. The cooling subsystem as recited in claim 1, wherein the working fluid is water.

5. The cooling subsystem as recited in claim 4, wherein the working fluid leaves the evaporator as steam.

6. The cooling subsystem as recited in claim 1, wherein the turbo generator is an expansion turbine configured to provide rotary motion to drive an electric generator to produce electric power.

7. The cooling subsystem as recited in claim 1, wherein cooling subsystem is a closed loop system.

8. A method of recycling waste heat generated by a fuel cell stack, the method comprising:
providing a closed loop cooling system, comprising an evaporator, a turbo generator, a condenser, and a pump;
operating a fuel cell stack;
capturing waste heat from the fuel cell stack in working fluid;
evaporating the working fluid; and
feeding the evaporated working fluid to a turbo generator to produce electric power.

9. The method as recited in claim 8, further comprising:
condensing evaporated working fluid exiting the turbo generator into a liquid; and
pressurizing the liquid; and
pumping the liquid into the evaporator.

10. The method as recited in claim 8, wherein capturing waste heat from the fuel cell stack in working fluid takes place in a heat exchanger, wherein the working fluid flows through the heat exchanger.

11. The method as recited in claim 10, wherein pumping the liquid into the evaporator comprises passing the liquid through the heat exchanger to capture waste heat from the fuel cell before the liquid enters the evaporator.

12. The method as recited in claim 9, wherein the working fluid is water.

13. The method as recited in claim 9, wherein the working fluid exits the evaporator as steam.

14. A method of generating electrical power using a cooling subsystem of a fuel cell assembly, the method comprising:
pressurizing a fluid in a condensed phase;
evaporating the fluid in an evaporator; and
feeding the fluid from the evaporator into an expansion turbine configured to provide rotary motion to drive an electric generator to produce electric power.

15. The method as recited in claim 14, further comprising:
condensing fluid from the expansion turbine into a liquid; and
pumping the liquid back to the evaporator.

16. The method as recited in claim 14, wherein fluid leaving the expansion turbine has a temperature and a pressure lower than a temperature and pressure of the fluid entering the expansion turbine.

17. The method as recited in claim 14, wherein the pressurized fluid in a condensed phase is water.

18. The method as recited in claim 17, wherein the fluid fed into the expansion turbine is steam.

19. The method as recited in claim 14, further comprising using a heat exchanger attached to a fuel cell stack to capture waste heat from the fuel cell stack in the fluid flowing through the heat exchanger.

20. The method as recited in claim 15, further comprising pumping the liquid through the heat exchanger before pumping the liquid back into the evaporator.
